(19) United States
(12) Patent Application Publication
(10) Pub. No.: US 2004/0033726 A1
(43) Pub. Date: Feb. 19, 2004

(54) Plug used for connection with a USB receptacle

(76) Inventor: Chi-Lei Kao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,563

(22) Filed: Oct. 30, 2002

(30) Foreign Application Priority Data
Aug. 16, 2002 (TW) 91118593

(51) Int. Cl. H01R 24/00

(52) U.S. Cl. 439/660

(57) ABSTRACT

A plug used for connection with a USB receptacle. The plug contains a plurality of metal contacts, which is used for contacting metal contacts of the USB receptacle when the plug is connected to the USB receptacle. It also contains a loader, which is used for loading the metal contacts of the plug. The plug has a thickness that is smaller than an ordinary USB plug, so it can be utilized by computer peripherals that have a thickness less than an ordinary USB plug.

### CROSS REFERENCE TO RELATED APPLICATIONS

This application claims the priority benefit of Taiwan application serial No. 91118593, filed on Aug. 16, 2002.

### BACKGROUND OF INVENTION

1. Field of Invention

The present invention relates to a connection plug. More particularly, the present invention relates to a plug, which can be connected to a receptacle of universal series Bus (USB) receptacle or a USB plug.

2. Description of Related Art

As the semiconductor fabrication technology has been developed day by day, the functional of the computer is much powerful and is much better than the first computer, which had ever been made. The operation speed and the storage capacity have been tremendously improved but the computer volume has been reduced a lot. When the semiconductor fabrication technology has been extremely developed and the network technology has been developed being popular, the current computer has been not only the definition of computer in the early stage. The compute now can be connected with the other computer in any place of the world via the network, so as to transmit and receive any type of information. Also and, the current computer can process a large amount of multiple media information. In order to conveniently transmit, receive and store various kinds of information, the peripheral devices of the computer system have enormous varieties. In inputting devices includes, for example, keyboard, mouse, scanner, or digital camera, and the outputting devices includes, for example, displaying device, printer, or other kinds of storage devices. New devices are continuously developed, according to the needs from the user. In order to allow these kinds of peripheral devices to communicate with computer, various kinds of input/output (I/O) interface standard have been proposed, in which one of the most common standards is the universal series Bus (USB) standard, in which one of the most common standards is the IEEE 1394 communication standard. The USB standard defines transmitting format and speed of information when the USB peripheral device is transmitting information with the computer each other. In addition, the appearance and specification for the plug, receptacle, and the cable connected between, which have been implemented on the peripheral device and the computer, have also been defined, and the same in the IEEE 1394 standard. In the USB standard, it includes the specification for the plug and the receptacle with respect to the series A, series B, series Mini-A, series Mini-B, and so on. Wherein, the series A, series Mini-A, and series Mini-B and mini IEEE 1394 are designed to arrange a set of metal connection terminals of the plug to be disposed on a plane of a holder, as well as the series B is designed to arrange a set of metal connection terminals to be disposed on the upper and lower planes of a holder. For a computer peripheral device using the USB as the I/O interface standard, various kinds of storage devices have been well noted, such as the USB silicon disk. This kind of portable storage device has the advantages that the volume is smaller than that of the conventional portable storage devices, such as the floppy disk. Therefore, it is very convenient for carriage. However, the space for storage device is much greater than the amount for the conventional portable storage device. Furthermore, the capability of plug-and-play has been included between the USB and the computer, so that it has the advantages to avoid the extra connection device and reduce the tedious operation processes in use.

Referring to FIGS. 1-6, FIG. 1 and FIG. 2 are the drawing, schematically illustrating the conventional connection structure for the plug 10 and the receptacle 20 for the USB series A. FIG. 3 and FIG. 4 are the drawing, schematically illustrating the conventional connection structure for the plug 100 and the receptacle 10 for the USB series Mini-A. FIG. 5 and FIG. 6 are the drawing, schematically illustrating the conventional connection structure for the plug 30 and the receptacle 40 for the USB series Mini-B. In FIG. 1, the plug 10 includes a number of metal connection terminals 12, used to connect to the metal connection terminals 22 on the first holder 24, which is implemented in the receptacle 20, when the plug is connected to the receptacle 20 as shown in FIG. 1. A second holder 14 is used to hold the metal connection terminals 12. A metal frame 16 is used to fit into an outer frame 26 of the receptacle 20 when the plug 10 is connected to receptacle 20, in which the four elastic plates 28 arranged in up side and the down side on the outer frame 26 can elastically contact to the metal frame 16, so as to affix the plug 10. In FIG. 3, the plug 100 includes a number of metal connection terminals 102, used to connect to the metal connection terminals 112 on the first holder 114, which is implemented in the receptacle 110, when the plug 100 is connected to the receptacle 110 as shown in FIG. 4. A second holder 104 is used to hold the metal connection terminals 102. A metal frame 106 is used to fit into an outer frame 116 of the receptacle 110 when the plug 100 is connected to receptacle 110, in which the three elastic plates 118 on the outer frame 116 can elastically contact to the metal frame 106, so as to affix the plug 100. Likewise, the plug 30 in FIG. 5 includes a number of metal connection terminal 32, used to connect to a number of connection terminals 42 implemented on a first holder 44 in the receptacle 40, when the plug 30 is connected to the receptacle 40 as shown in FIG. 6. A second holder 34 is used to hold the metal connection terminals 32. A metal frame 36 is used to fit into an outer frame 46 of the receptacle 40 when the plug 30 is connected to receptacle 40, in which the three elastic plates 48 on the outer frame 46 can elastically contact to the metal frame 36, so as to affix the plug 30. However, in order to have the affixing function, the metal frame 16 is used to accept the first holder 24 when the plug 10 is connected to the receptacle 20, in which a second space 16a exits between the metal frame 16 and the second holder 14. The second space 16a determines the thickness of the metal frame 16 as well as the thickness of the plug 10. In order to have the affixing function, the metal frame 106 is used to accept the first holder 114 when the plug 100 is connected to the receptacle 110, in which a second space 106a exits between the metal frame 106 and the second holder 104. The second space 106a determines the thickness of the metal frame 106 as well as therefore the thickness of the plug 100. Likewise, in order to have the affixing function, the metal frame 36 is used to accept the first holder 44 when the plug 30 is connected to the receptacle 40, in which a second space 36a exits between the metal frame 36 and the second holder 34. The second space 36a determines the thickness of the metal frame 36 as well as therefore the thickness of the plug 30. Therefore, when a designer for the peripheral device of the computer system intends to reduce the peripheral device, which uses the USB as the I/O interface standard, the designer will be limited by the thickness of the plug 10, 100 and 30 and cannot design a peripheral device with a thinner appearance than the thickness of the plugs 10, 100, or 30.

For example, the USB silicon disk in the current market, the appearance is always designed to be a thin rectangular volume with a limitation of thickness by the thickness from the plug 10, 100 and 30 without being further reduced in thickness. Also and, the current memory card device usually has its standard size specification, such as, the IC card, which is usually used as the telephone card or the credit card, the compact flash (CF) card and the secure digital (SD) card used in digital camera as the storage unit, the memory stick card, the multi medial card, the smart media card, the MG memory stick card, the XD picture card, the memory stick duo card, the Microdrive card, and so on. Due to the foregoing reasons, those cards should need an extra access apparatus with a cable connection and cannot be directly connected to the computer system via the USB series A receptacle for communication.

Also and, the CF card has the thickness of 0.33 cm but the USB plug, such as the series A, is thicker, such as 0.45 cm. If the thickness of the CF card is changed to 0.45 cm then it cannot be plugged into the CF slot of the digital camera. The computer uses the USB interface with the USB series A receptacle. In this situation, the CF card with the thickness of 0.33 cm cannot be installed with the convenient USB series A plug for directly connecting to the computer USB series A receptacle and providing a convenient way in data transmission. Thus, it needs a CF card reader to read data from CF card and through reader convenient USB series A plug for directly connecting to the computer USB series A receptacle. A USB “mini” type connector can be put in a CF card, but still needs a USB cable with “Mini” to “A” connector convert function, Otherwise it still can't directly connect a CF card into a computer common USB series A receptacle.

### SUMMARY OF INVENTION

In the invention, a user can directly connect an additional connector of a CF card or a memory card to a USB series A receptacle. Further in the invention, the portable information storage device, which is connected to the peripheral device, can use the USB to connect to the computer, so that the use is more convenient.

The present invention provides a USB plug, which has different appearance from the conventional appearance but can be connected to a plug or a receptacle of the USB series A, series Mini-A, series Mini-B, series Mini-AB, so that the conventional issue about the over large thickness of the USB plug can be solved.

The invention has an objective to provide a USB plug and a Mini IEEE 1394 plug, which has different appearance from the conventional appearance and is exposed and like a connection terminals.

The invention provides a plug, which is used to connect to a USB receptacle or a USB plug. The receptacle has an outer frame, a plurality of elastic member disposed on the inner side of the outer frame, and a first holder having a plurality of metal connection terminals. The plug includes a plurality of metal connection terminals, used to connect to the metal connection terminals of the receptacle when the plug is electrically connected to the receptacle. A second holder is used to hold the metal connection terminals of the plug. The USB plug has an outer frame and a first holder on which a plurality of metal connection terminals have been disposed.

The invention is a design which is different from the conventional design of the USB plug implemented with the metal frame by an over large thickness or a holder with over large thickness, so that the issue of over thickness of the USB plug can be solved.

The present invention uses an independent memory card associating with a master card, which can be individually dismounted with the memory card. For example, the independent memory card has a long rectangular shape, like a USB silicon disk as a memory card. The master card, for example, is a multifunctional CF card. The independent memory card can be mounted or dismounted from the master card. In this manner, when the independent memory car is to be connected to the USB connector of the computer, the space is not be restricted by the master card.

The present invention can also be applied to the design of the IEEE 1394 plug, which conventionally has a metal frame, causing an over large thickness. As a result, the thickness of the conventional IEEE 1394 can be reduced.

The objective of the invention includes providing an apparatus, which has an architecture of at least dual connector, allowing an inner-disposition single information storage card to be connected, wherein the single storage memory information storage card has at least one or two different connectors . The dual connector can also connect with the single information storage card with one or two connector. As a result, the number of slots for adapting multiple memory cards can be reduced and the volume is therefore reduced. This is convenient for design in adapting the storage memory card with at least two different connectors or one connector. It is also convenient to be connected to the computer USB for data access.

One of the objectives in the invention is to provide a connection device with at least dual connectors, so as to connect to the connector of a single information storage card with at least two different connectors or one connector.

One of the objectives in the invention is to provide a connector of an inner device of a computer peripheral apparatus. The connector can be implemented on an insert portable memory device to transfer data with USB mass storage protocol. The portable memory device is inserted to a computer, and the computer uses the same. USB mass storage protocol to transfer data to portable memory device, which can be dismounted and is connected to the USB connector of the computer in convenience. Also and, the portable memory device can be designed to be separated into two parts, so that when they are put together, it is suitable to insert into a slot. The separated part can include the memory card and a controller and has a connector to connect a device USB port. The function is like a USB silicon disk, but the size is small and long and thin for easy insert, so as to avoid the problem caused by too large area size. For example, for a CF card with a mini USB connector, the insertion of the CF card may touch the cables nearby, and against connector insertion to a USB port action, a CF card with rotate out connector, will support a long thin connector too.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings

FIG. 1 is a drawing, schematically illustrating a plug for USB series A;

FIG. 2 is a drawing, schematically illustrating a receptacle for USB series A;

FIG. 3 is a drawing, schematically illustrating a plug for USB series Mini-A;

FIG. 4 is a drawing, schematically illustrating a receptacle for USB series Mini-A;

FIG. 5 is a drawing, schematically illustrating a plug for USB series Mini-B;

FIG. 6 is a drawing, schematically illustrating a receptacle for USB series Mini-B;

FIG. 7 is a drawing, schematically illustrating a plug, according to an embodiment of the invention;

FIG. 8 is a drawing, schematically illustrating a metal frame of the plug with one protruding part in FIG. 7;

FIG. 9 is a drawing, schematically illustrating a metal frame of the plug with one opening in FIG. 7;

FIG. 10 is a drawing, schematically illustrating a second holder of the plug with one protruding part in FIG. 7;

FIG. 11 is a drawing, schematically illustrating the plug with a protection cover as shown in FIG. 7;

FIG. 12 is a drawing, schematically illustrating the second holder of the plug with a reduced thickness FIG. 7;

FIG. 13 is a drawing, schematically illustrating the plug in FIG. 7 for application on a silicon disk;

FIG. 14 is a drawing, schematically illustrating the plug in FIG. 7 for application on an IC card;

FIG. 15 is a drawing, schematically illustrating the plug in FIG. 7 for application on a CF card;

FIG. 16 is a drawing, schematically illustrating the plug in FIG. 7 for application on an SD card;

FIG. 17 is a drawing, schematically illustrating the plug in FIG. 7 about the mechanism of using the cable to connect with outer devices; and

FIG. 18 is a drawing, schematically a plug with reduced thickness, according to the invention.

### DETAILED DESCRIPTION

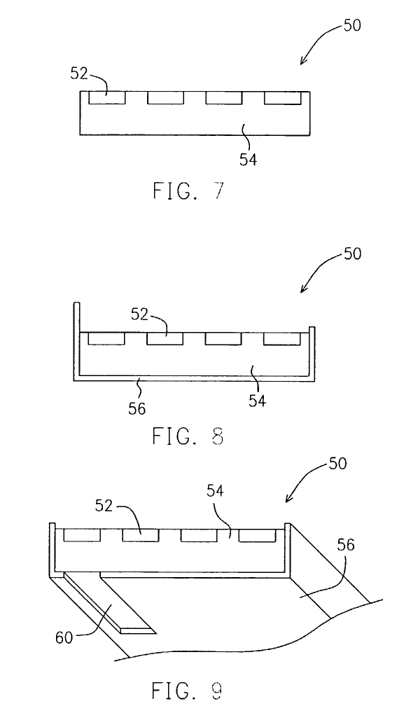

Referring to FIG. 7, FIG. 7 is a drawing, schematically illustrating a plug 50, according to an embodiment of the invention. In FIG. 7, the plug 50 includes a number of metal connection terminals 52 being exposed, used to electrically connect to a number of metal connection terminals 22 on a first holder 24 inside the receptacle 20 when the plug 50 is connected with the receptacle 20 in FIG. 2. A second holder 54 is used to hold the metal connection terminals 52 and at least one at bottom of the elastic plate 28 on the outer frame 26 of the receptacle 20 when the plug 50 is connected with the receptacle 20, or two elastic plates 54 at bottom are to elastically contact the second holder 54. So, it affixes the plug 50, in which at least one of the multiple elastic plates 28 on the outer frame 28 at the top will not contact with the plug 50. Wherein, each element in the plug 50 can have correspondingly similar specification and appearance, so as to assure that the USB plug 50 is compatible with the USB receptacle 20. However, the specification and the appearance can also be modified. For example, the metal connection terminals 52 can be the protruding points. It has been sufficient to only need a good contact between the metal connection terminals 52 of the plug 50 and the metal connection terminals 22 of the receptacle 20. It is also not always necessary for the second holder 54 to cover the bottom of the metal connection terminals 52. The second holder 54 can, for example, only hold the metal connection terminals 52 from the bottom for affixing. The plug 50 can also include an outer frame of a metal frame 56 or a non-metal frame, so as to connect to the outer frame 26 of the receptacle 20. One of the purposes of the second holder 54 or the metal frame 56 is to connect in contact with the outer frame 26 of the receptacle 20, so as to provide the affixing function by contact. However, the second holder 54 can be properly adjusted on the thickness, so as to assure that the elastic plates 28 can have the affixing effect. Since the multiple metal connection terminal 22 on the first holder 24 are the design of elastic plates, it not only can assure the electric connection with the metal connection terminals 52 on the second holder 54, but also it has the affixing effect on the plug 50 by associating with the multiple elastic plates 28. The conventional USB plug 10 has the thickness of 0.45 cm, and the plug 50 has the minimum thickness, which allows to be plugged into the space between a bottom of the outer frame 26 of receptacle 20 and the first holder 24, wherein it has been sufficient to allow the multiple metal connection terminals 52 to have good contact with the multiple metal connection terminals 22 on the receptacle 20. The thickness can be less than 0.24 cm or even down to about 0.18 cm. Optionally, a protruding part for avoiding a reverse connection can be included, in which some portion would be thicker. However, the thickness of the plug 50 can be less than the USB series A plug 10 by 0.45 cm or down to less than 0.38 cm. In this manner, it can be implemented on a CF card with thickness of 0.33 cm, a memory stick card with thickness of 0.28 cm, a SD card with thickness of 0.21 cm, a XD card with thickness of 0.17 cm, a memory stick duo card with thickness of 0.16 cm, a Microdrive card, a PCMCIA card, or a thinner USB silicon disk or HD, since the plug 50 can be used in light and small portable memory device, , the plug 50 structure still support enough strength connect to a receptacle.

When the plug 50 is connected to the receptacle 110 in FIG. 4, the metal connection terminals 52 being exposed are used to electrically connect the multiple metal connection terminals 112 on the first holder 114 inside the receptacle 110. The second holder 54 is used to hold the metal connection terminals 52 and affix the plug 50, wherein at least one of the multiple elastic plates 118 on the outer frame 116 of the receptacle 110 can elastically contact the second holder 54 to affix the plug 50 when the plug 50 is connected to the receptacle 110. Wherein, each element of the plug 50 can have the similar specification and appearance with the corresponding elements of the USB plug 100, which is to be connected to the USB receptacle 110, so that the plug 50 is compatible with the USB receptacle 110. However, the specification and the appearance can be changed. For example, the metal connection terminals 52 can be the protruding points. It has been sufficient to only need the good contact between the metal connection terminals 52 of the plug 50 and the metal connection terminals 112 of the receptacle 110. It is also not always necessary for the second holder 54 to cover the bottom of the metal connection terminals 52. The second holder 54 can, for example, only hold the metal connection terminals 52 from the bottom for affixing. The second holder 54, in thickness, can be properly adjusted to assure that the elastic plates 118 can effectively perform the affixing function. Since the multiple metal connection terminal 112 on the first holder 114 are the design of elastic plates, it not only can assure the electric connection with the metal connection terminals 52 on the second holder 54, but also has the affixing effect on the plug 50 by associating with the multiple elastic plates 28.

Likewise, when the plug 50 is connected to the receptacle 40 in FIG. 6, the metal connection terminals 52 being exposed, are used to electrically connect the multiple metal connection terminals 42 on the first holder 44 inside the receptacle 40. The second holder 54 is used to hold the metal connection terminals 52 and affix the plug 50, wherein at least one of the multiple elastic plates 48 on the outer frame 46 of the receptacle 40 can elastically contact the second holder 54 to affix the plug 50 when the plug 50 is connected to the receptacle 40. Wherein, each element of the plug 50 can have the similar specification and appearance with the corresponding elements of the USB plug 30, which is to be connected to the USB receptacle 40, so that the plug 50 is compatible with the USB receptacle 40. However, the specification and the appearance can be changed. For example, the metal connection terminals 52 can be the protruding points. It has been sufficient to only need the good contact between the metal connection terminals 52 of the plug 50 and the metal connection terminals 42 of the receptacle 40. It is also not always necessary for the second holder 54 to cover the bottom of the metal connection terminals 52. The second holder 54 can, for example, only hold the metal connection terminals 52 from the bottom for affixing. The second holder 54, in thickness, can be properly adjusted to assure that the elastic plates 48 can effectively perform the affixing function. Since the multiple metal connection terminals 42 on the first holder 44 are the design of elastic plates, it not only can assure the electric connection with the metal connection terminals 52 on the second holder 54, but also has the affixing effect on the plug 50 by associating with the multiple elastic plates 48. The USB series mini-A plug 30 or the mini-B plug 100 have the thickness of 0.3 cm. The minimum thickness of the plug 50, which allows to be plugged into the space between a bottom of the outer frame 46 of receptacle 40 and the first holder 44. Wherein, it has been sufficient to allow the multiple metal connection terminals 52 to have good contact with the multiple metal connection terminals 42 on the receptacle 40. The thickness of the plug 50 can be less than 0.15 cm or even down to about 0.08 cm. Optionally, a protruding part for avoiding a reverse connection can be included, in which some portion would be thicker. However, the thickness of the plug 50 can be less than the 0.3 cm. Thickness USB series mini-A plug 40 and mini-B plug 110. In this manner, it can be implemented on a CF card with thickness of 0.33 cm, a memory stick card with thickness of 0.28 cm, a SD card with thickness of 0.21 cm, a multimedia card by 0.14 cm, a smart card with thickness of 0.076 cm, a XD picture card with thickness of 0.17 cm, a memory stick duo card with thickness of 0.16 cm, a Microdrive card, a PCMCIA card or a thinner USB silicon disk. Since the plug 50 be used in light and small portable memory device, the plug 50 structure has enough strength support connect to a receptacle.

Referring to FIG. 8 and FIG. 9, in order to keep some affixing function for the metal frame of the conventional USB plug when the USB plug is connected to the USB receptacle and is affixed, under the condition without affecting the thickness of the plug 50, a metal frame 56 can be implemented on the bottom or on the edge of the second holder 54 in the plug 50. In this manner, the metal frame 56 is used to affix the plug 50 to the outer frame 26, 116, 46 of the receptacle 20, 110, 40 by contact friction and the outer appearance. When the user accidentally intends to connect the plug 50 to the receptacle 20, 110, or 40 in reverse direction, the power source terminal Vcc and the grounding terminal GND of the metal connection terminals 22, 112, or 42 of the receptacle 20, 110, or 40 may have contact with the metal frame 56. Since the material of the outer frames 26, 116, or 46 are metallic material, when the power source terminal and the grounding terminal contacts each other, a short circuit will occur. This short circuit is easy to cause the receptacle 20, 110, or 40 to be breakdown or malfunction for the device using the receptacle 20, 110, or 40.

Please note that, in the USB series A in FIG. 2, the receptacle 20 has a first space 26a between the first holder 24 and the outer frame 26. This conventional design is used to adapt the metal frame 16 when the USB series A plug 10 is connected with the receptacle 20. In FIG. 4 for the USB series Mini-A, the receptacle 110 has a first space 116a between the first holder 114 and the outer frame 16. This conventional design is used to adapt the metal frame 106 when the USB series Mini-A plug 100 is connected with the receptacle 110. In FIG. 6 for the USB series Mini-B, the receptacle 40 has a first space 46a between the first holder 44 and the outer frame 46. This conventional design is used to adapt the metal frame 36 when the USB series Mini-B plug 30 is connected with the receptacle 40.

FIG. 8 is a drawing, schematically illustrating the plug 50 according to the first embodiment of the invention. In FIG. 8, at least one side of the metal frame 56 of the plug 50 has protruding part by a distance from the second holder 54. The metal frame 56 will be plugged into the first space 26a, 116a, or 46a when the plug 50 is connected to the receptacle 20, 110, or 40. When the plug 50 is connected in reverse direction, since the shape for the first space 26a, 116a, or 46a is different from the right connection, the metal frame 56 will not be smoothly plugged into the first space 26a, 116a, or 46a. By this mechanism, it can prevent a reverse connection for the metal frame 56 from occurring. FIG. 9 is a drawing, schematically illustrating the plug 50 according to the second embodiment of the invention. In FIG. 7, the metal frame 56 of the plug 50 has an opening part 60. The opening part 60 is located at the place, where would match to the power source terminal of the metal connection terminals 22, 112, or 42. In this manner, when the plug 50 is connected in reverse direction to the receptacle, the short circuit will not occur between the power source terminal and the grounded terminal although the power source terminal has contacted with the metal frame 56.

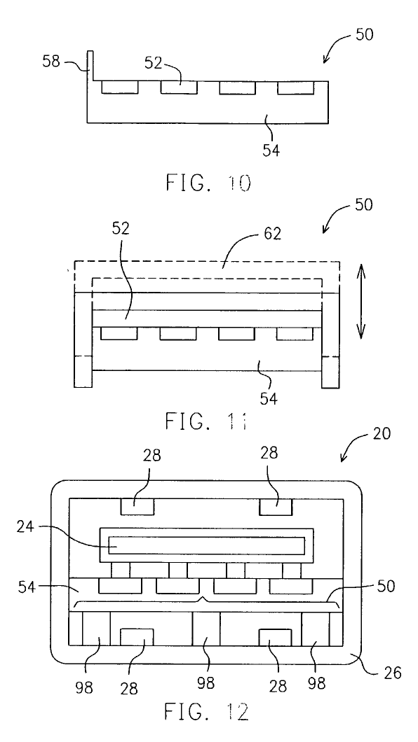

Referring to FIG. 10, FIG. 10 is a drawing, schematically illustrating the plug 50 according to the third embodiment of the invention. With similar foregoing reasons, in order to prevent the reverse connection for the plug 50 to the receptacle 20, 110, or 40, the plug 50 is designed to have at least one protruding part 58 at the edge of the second holder 54. The protruding part 58 will be inserted into the first space 26a, 116a, 46a when the plug 50 is connected to the receptacle 20, 110, or 40. When the plug 50 is connected in reverse direction, since the shape for the first space 26a, 116a, or 46a is different from that in right connection. The protruding part 58 then cannot be smoothly inserted into the first space 26a, 116a, or 46a. In this manner, the protruding part 58 can prevent the plug 50 from being reverse connection. An LED can also used to indicate whether or not the connection is correction. Furthermore, for example, since mini type IEEE 1394 plug and receptacle has the same structure as USB mini type connector, but with different pin pitch and size and different connector shape and size, the way of thickness modify done in USB connector, also can done in IEEE 1394 mini plug connector.

Referring to FIG. 11, FIG. 10 is a drawing, schematically illustrating the plug 50 according to the fourth embodiment of the invention. The metal connection terminals 52 of the plug 50 in the invention is exposed over the second holder 54. In order to prevent the metal connection terminals 52 from being broken by the external force or dirt during the usual state without connection, the second holder 54 can be implemented with a protection cap 62 thereon, which is implemented on by a retractable manner. When the plug 50 at the usual time without being connected, the protection cap 62 can be retracted and is tightly adjacent to the metal connection terminals 52, so as to reduce the thickness of the plug 50. When the plug 50 is connected to the receptacle 20, 110, or 40, the protection cap 62 then can be shifted out, for example by elastic manner, so that the first holder 24, 114 or 44 can be located between the protection cap 62 and the second holder 54. Thereby, it can prevent the plug 50 from being connected in reverse.

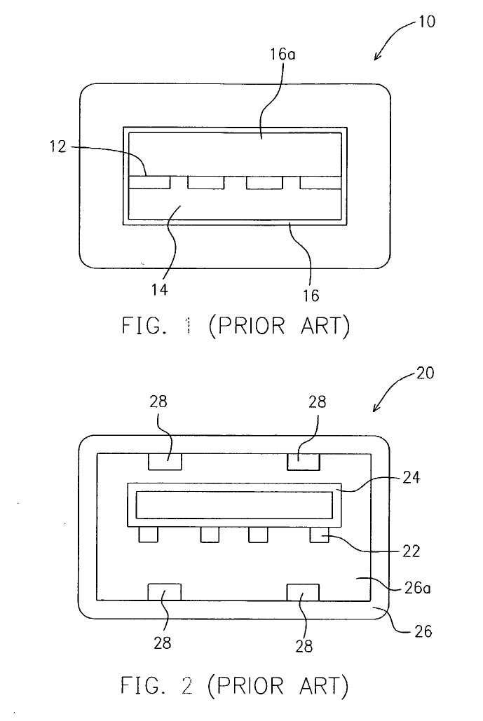

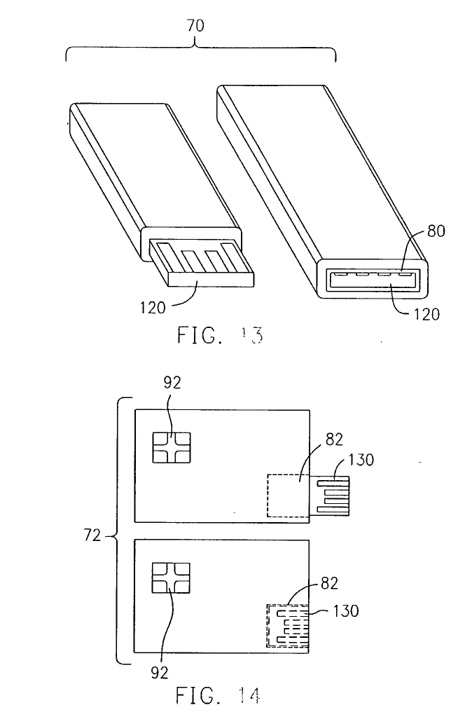

Referring to FIG. 12, FIG. 12 is a drawing, schematically illustrating the plug 50 according to the fifth embodiment of the invention, wherein the actual situation is shown when the plug 50 of the invention is connected to the USB receptacle 20, 40, 110 in FIGS. 1, 4, and 6. For convenient descriptions in FIG. 1, the receptacle 20 is used as the example. In order to further reduce the thickness of the plug 50 with respect to various needs, the thickness of the plug 50 can be reduced down to a degree, at which the plug 50 second holder 54 will not contact with the elastic plates 28, 48, 11 8 when the plug 50 is connected to the receptacle 20, 40 and 110, and the second holder 54 in the plug 50 can be implemented with a number of elastic plates 98 at the bottom side to have contact with the metal frame of the receptacle 20, 40, 110. Or, second holder 54 have a metal frame rack in bottom or both side touch the bottom outer frame of receptacle 20, 110, or 40, is used to strengthen the connection effect. The metal connection terminals 52 of the plug 50 can be a design of elastic plate.

In the invention, the plug 50 and the embodiments 1-5 have disclosed several options. The plug 50 of the invention can effectively reduce the thickness of the conventional USB plug, so as to be suitable for use in various computer peripheral devices. The present invention can be also applied to a mini type IEEE 1394 connector with four metal connection terminals, which is similar to the mini USB connector. The different is the size and the outer appearance. However, the connection mechanism between the plug and the receptacle are similar to the mechanism in the USB case. The present invention can also be applied to the mini type IEEE 1394 connectors. Referring to FIGS. 13-16, FIG. 13 is the example for actual application using the plug 50 as shown by a plug 120, which is implemented on a USB silicon disk drive 70 without using the manner of cable connection. Wherein, the plug 120 can be the plug 50 shown in FIG. 7. The silicon disk drive 70 has a indent space 80. The plug 120 can be implemented on the indent space 80 by a non-retractable manner. The plug 120 can also be implemented on the silicon disk drive 70 by a protruding and non-retractable manner. The protruding plug 120 can be directly connected to a USB receptacle, and the receptacle 20, 110, 04 40 of a cable can also be directly connected to the plug 120 on the indent space 80. The plug 120 can also be implemented in the indent space 80 by the retractable manner. When the plug 120 is to be connected to the receptacle 20, 110 or 40, the plug 120 can then be shifted out from the indent space 80. When the plug 120 is not to be connected to the receptacle 20, 110, or 40, the plug 120 can be retracted into the indent space 80.

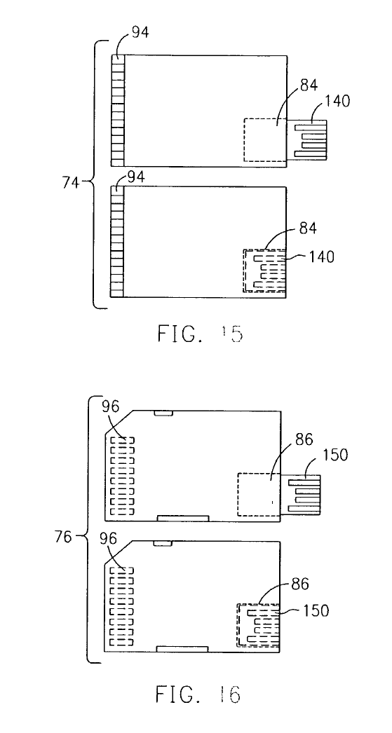

FIG. 14 is the example for the second actual application using the plug 50 as shown by a plug 120. An IC card 72 has the metal connection terminals 92 used by a reading apparatus to read data, but also has a plug 130, which can be the plug 50 shown in FIG. 7 and is implemented on the IC card 72 without cable connection. The IC card 72 has an indent space 82. The plug 130 can be implemented on the indent space 82 or protruding from the IC card 72 by a non-retractable manner. The receptacle 20, 110, 04 40 of a cable can also be directly connected to the plug 130 in the indent space 82. The plug 130 can also be implemented in the indent space 82 by a retractable manner. When the plug 130 is to be connected to the receptacle 20, 110 or 40, the plug 130 can then be shifted out from the indent space 82. Alternatively, the plug 130 can also be disposed in the indent spacer 82 and when it is to be used, the plug 130 is shifted out by rotating an angle of 90 or 125 degree or others. The metal connection terminals of the plug 130 being shifted out are connected to the chip of the IC card 72 via a conductive line, so that the plug 130 can be directly connected to the receptacle 20, 110, or 40 of the computer. When the plug 130 is not to be connected to the receptacle 20, 110, or 40, the plug 130 can be retracted into the indent space 82.

FIG. 15 is the example for the third actual application using the plug 50 as shown by a plug 140. A CF card 74 has a slot 94 for use by digital camera to access the data. Also and, a plug 140 is implemented on a CF card 74, wherein the plug 140 can be the plug 50 in FIG. 7. The CF card 74 has an indent space 84. The plug 140 can be implemented in the indent space 84 by a non-retractable manner, wherein the plug 140 can also be exposed. The receptacle 20, 110, 04 40 of a cable can also be directly, connected to the plug 140 in the indent space 84. The plug 140 can be implemented in the indent space 84 by a retractable manner. When the plug 140 is to be connected to the receptacle 20, 110 or 40, the plug 140 can then be shifted out from the indent space 84. Alternatively, the plug 140 can be disposed in the indent spacer 84 and when it is to be used, the plug 140 is shifted out from the CF card by rotating an angle. The plug 130 can thereby be directly connected to the receptacle 20, 110, or 40 of the computer. When the plug 140 is not to be connected to the receptacle 20, 110, or 40, the plug 140 can be retracted into the indent space 84. The appearance of the CF card 74 is then returned and can be inserted into the slot of the digital camera, a memory card with a long-thin shift out plug 40, will be easier to inset into receptacle, because a CF size will touch other nearby cable and against the inset action , this is the reason why USB silicon disk was long-thin shape.

One design is as follows. Plug 140 also can be shifted out from the CF card (master card ) or other memory card, together with at least one memory card and at least one controller chip. As a result, it becomes an independent memory card, the controller chip for controlling the data storage and transmission can be integrate into the memory card. The controller has the function to control the system and data transfer. As a result, after the plug with the memory card is shifted out, the shifted-out independent memory card can be complete separated from the master card, or alternatively still has some mechanical connection without complete separation. Thus, it is convenient for the action of retracting back into the master card. The master card can optionally include one controller chip for controlling the information transmission. The independent memory can be inserted into a computer USB port, and become an independent memory card, like a USB memory card. Therefore, it is smaller than a CF card and can be designed with long thin shape to easy insertion to the slot. The independent memory card can be retracted back to the master card.

There are many options about how the data is transferred between the memory to the inserted digital camera device, and many different connector design option. One design is that the plug 140 of the memory card on the CF card (master card) can also be directly connected to a connector inside a digital camera for information communication, so that the function of the master card can be only to mechanically support independent memory card and the mechanical member for insertion into the CF slot. One option is that the independent memory card have at least two connectors, of which in addition to the 140 plug, another connector A can be included for direct connection with a connector B, which is installed inside of the digital camera. In this manner, a CF card (master card) may be not necessary to include a connector C with 50 pins required by the conventional CF card or a controller. I It can be seen that the only need for the master card is the connection function to insert into the affixed slot.

Alternatively, the independent memory card can include at least dual connectors, of which one is the plug 140 and another one is a connector A, which can be connected to a connector B on the CF card. The connector B of the CF card can be used for signal transmission or other uses. The CF card can include a connector C with the conventional 50 pins and a controller, so that it provides for the external electronic device to connect on the connector C via the 50 pins. In this manner, the signals for CF card can be converted into the signals of USB protocol and then used by the independent memory card. Alternatively, the CF card can only be simply the connector C with conventional 50 pins for connecting the external electronic device at the connector B, so that the information data can be transmitted to the memory card on the CF card (master card). Furthermore, the CF card can also be treated as only a mechanical support member without limitation by the function of actual connection.

The another design is a memory card architecture, which can include a master card. The master card has an I/O port, capable of connecting with a first external electronic device. A controlling unit is implemented on the mater card, used to convert the I/O port into a USB interface. A memory card having another control unit and a USB interface I/O port member is capable of connection with a second external electronic device. Wherein the memory card can be mounted on the master card as a choice from a user, and by a mechanical operation or a direct connection, the USB interface I/O port member can be coupled with the USB interface. Wherein only one at a time can be selected for information communication from the group consisting of case 1 that the USB interface I/O port member of the memory card is coupled with the USB interface and case 2 that the USB interface I/O port member of the memory card is coupled with the second external electronic device.

In the forgoing architecture, the controlling unit can convert the different signal protocol to the USB signal transmission protocol. The USB interface I/O port member can be, for example, like the structure as shown in FIG. 18 with the rotation part, in which when the connector is put back by, i.e., hand, then it is connected to the USB interface of the master card. When the memory card is mounted on the master card, the two control units can be optionally coupled together.

The foregoing design of master card with the independent memory card can also be applied to the other kinds of memory card. The independent memory card can be retracted into the CF card, and then the CF card can be inserted into the CF slot in, for example, a digital camera. The CF card has the multiple function to provide for, i.e., a USB silicon disk (independent memory card) being coupled together. The independent memory card can be a long thing structure, so that the independent memory card can be plugged into the plug 140 of the computer, without being restricted by the size of the CF card.

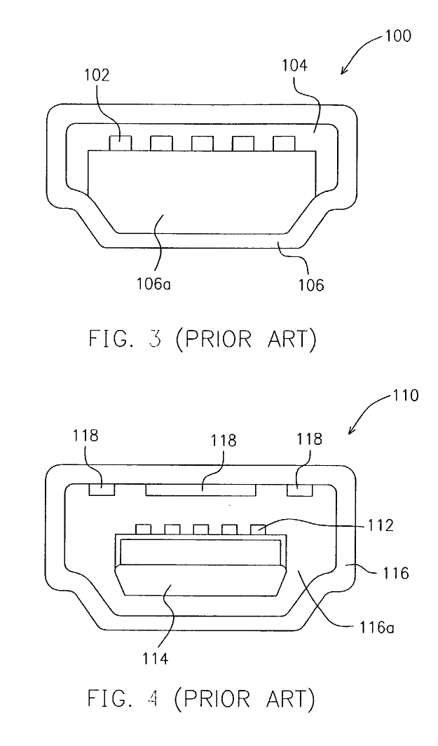

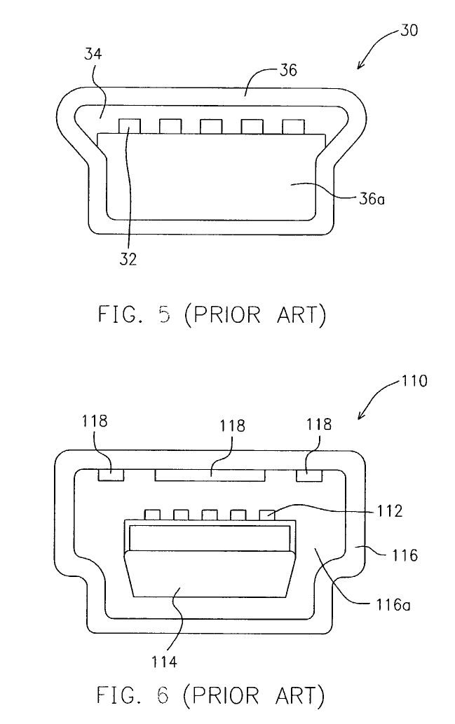

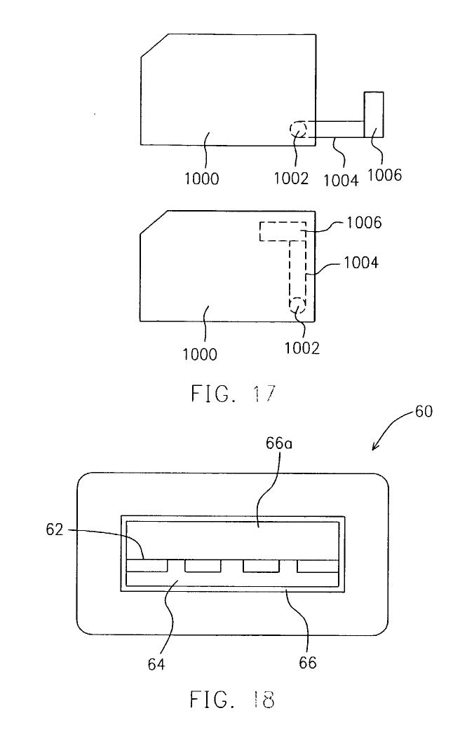

FIG. 16 is the example for the fourth actual application using the plug 50 as shown by a plug 150. A SD card 76 has a slot 96 for use by digital camera to access the data. Also and, a plug 150 is implemented on the SD card 76, wherein the plug 150 is implemented on the SD card without cable, wherein the plug 150 can be the plug 50 in FIG. 7. The SD card 76 has an indent space 86. The plug 150 can be implemented in the indent space 86 by a non-retractable manner, wherein the plug 150 can also be exposed. The receptacle 20, 110, 04 40 of a cable can also be directly connected to the plug 150 in the indent space 86. The plug 150 can also be implemented in the indent space 86. When the plug 150 is to be used, the plug 150 can be shifted out by rotating an angle. The plug 150 can also be implemented in the indent space 86 by the retractable manner. When the plug 150 is to be connected to the receptacle 20, 110, or 40, the plug 150 would be shifted out from the indent space 86. When the plug 150 is not to be connected to the receptacle 20, 110, or 40, the plug 150 can be retracted into the indent space 86. The plug 150 can also be implemented by protruding out from the SD card 76 without retraction. The protruding plug 150 can be directly connected to the USB receptacle of the computer. The SD card can also be disposed into the slot in a digital camera. The plug 120, 130, 140, 150 as shown in FIGS. 13-16 can also be uses in the USB series A plug 10 in FIG. 1, the USB series Mini-A plug 100 in FIG. 3, or the USB series Mini-B plug 30 in FIG. 5.

In the fifth application of the plug 50 in the invention, the metal connection terminals 52 can be changed into, i.e., elastic plates, so as to allow a connector to be inserted into. The connector can be the USB plug 30, 10, 100 in the computer. Likewise, the plug can also be connected to the USB receptacle, or even a reversed arrangement of the plug 50 suitable for use in the actual design.

In application 6, it is related to a design of the connectors for the peripheral equipment of the computer and an information storage device. The computer system is, for example, a notebook computer, and the information storage device, for example, is a PDA or storage device. For the storage device of the digital camera, it is, for example, a CF card. After the CF card is released out from the peripheral device of computer, conventionally it needs a reading apparatus to read the information. The information in the CF card can be input to the USB port of the computer via the reading device with the USB connector. The portable information storage device inside the peripheral device of computer can be a silicon disk or memory device, implemented with the conventional plug of USB series A 10, USB series Mini-A 100, or series Mini-B 30. The silicon disk or memory device can also be implemented with a plug of the invention, which can be connected to the receptacle or the plug of USB series A, USB series Mini-A, series Mini-B, series Mini-AB. The silicon disk or memory device can be disposed inside the peripheral device of computer. The peripheral device of computer is implemented with a connector, which can be connected with the plug. This connector can be the receptacle in USB series A 10, USB series Mini-A 100, or series Mini-B 30, or can be the plug 50. In this design, The computer system can download data to the portable information storage with USB mass storage class protocol, the portable information storage device of the peripheral device can be released out and be directly connected or connected via a cable, as shown in FIG. 17. The cable can be, for example, the cable used for converting the receptacle into the plug, in which the data signals are not changed and can be directly connected to the USB port of the computer, and can be read data with USB mass storage class protocol. In this manner, it is convenient for reading the information of the portable information storage device. In FIG. 17, an information storage card 1000 is implemented with the plug 1006 of the invention compatible with the USB specification. The plug 1006.is disposed on the rotation arm 1004. The rotation arm 1004 is mounted on the information storage card 1000 via a rotation member 1002, in which the interconnection line (not shown) is used to extend the connection terminals to the plug 1006. Moreover, as shown in FIG. 16 or FIG. 17, the plug 1006 can also be designed to be directly connected to a connector, even the plug remains in the retraction position, the rotated-out plug can be implemented in memory card or a hard disk, or a PCMCIA card.

In general, the peripheral device of computer can be implemented with a receptacle to be connected to a plug. The plug is implemented on a portable information storage device inside the peripheral device and is to be connected to the receptacle. The portable information storage device can be released out and is directly connected, via the plug, to a USB receptacle in an apparatus, or the portable information storage device can be released out and is connected by cable, via the plug, to a USB receptacle in an apparatus.

For the seventh application, the storage device in the market used by the digital camera has the design of dual slot and dual card, such as the CF slot and SD slot. The peripheral device of computer in implemented with two connectors as a dual connector for adapting the two cards. The user can select one of the two cards to plug into the digital camera. However, since it needs to be implemented with the dual slot, it then needs a larger volume. The invention proposes that the digital device has at least two connectors, being able to connect one slot with one inserted single memory car. The CF card can have the original connector with 50 pins, but also have another connector, so as to form a dual-connector card. For example, the another connector can be the exposed plug 50 of the invention, which can be connected to the receptacle of, for example, USB series A, series Mini-A, or Mini-B. Alternatively, the another connector on the card can be the usual USB plug of USB series A, series Mini-A, or Mini-B. The peripheral device is implemented with two connectors inside. The two connectors can be to the two connectors of the portable information storage device, which has been inserted. For example, The information storage device has the receptacle for CF card, SD card, or multimedia card as well as another connector. This another connector can be the exposed plug 50 of the invention, which can be connected to the plug or receptacle of, for example, USB series A, series Mini-A, or Mini-B. The peripheral device can detect and select one of the two connectors to read the information on the information storage device. In this design, the user has multiple choices to select the portable information storage device. One choice is the CF card, which can be read by the card reading apparatus. One choice is the card with dual connector, in which one connector can be the USB plug of series A, series Mini-A, or series Mini-B, as well as the other connector is the connector of the CF card to connect to the silicon disk or memory device. The memory device has a CF card slot with about conformal shape with the appearance of the CF card, so that it can be released and connected to a computer for reading the information via the USB port. The digital camera can also select a fast transfer rate USB 2.0 to send data to this memory card. One choice is also the card with dual connector, in which one connector can be plug 50 of the invention capable of connecting to the USB plug, or the plug 60 (see FIG. 18, the 10^{th} applications latter). Then, another connector is a CF connector for the silicon disk or memory card. The connection can be the CF slot about conformal to the CF card, is the connector of the CF card to connect to the silicon disk or memory device. One choice is the silicon disk or memory device, which has the CF slot about conformal to the CF card, implemented with a plug 50 or plug 60 of the invention, for connecting to USB series A, series Mini-A, or series Mini-B. Another option is that a design of the CF card like the embodiment three has a master card with the independent memory card. The peripheral device of the computer is implemented with at least two connectors, so that one of the connector of the master card and the connector of the independent memory card, or a single connector to connect to the master card or the independent memory card.

The connecting part inside the peripheral device at least includes two connectors. The peripheral device of computer can have a single slot, allowing different card to be plugged in, wherein the slot can be connected to the at least two connectors or single connector on the card, which has been plugged into the single slot. In this manner, for example, it only needs a CF-card slot, which is rather small in size, and can allow the different information storage cards to be plugged in for use. Optionally, a faster transfer data connection can used, when the card has this kind of connector, and still keep the function to connect a standard one connector CF card, which was being used a lot. This method is also suitable for use in the memory card with different specification.

The computer peripheral device can use inner connector satisfying the protocol of the windows operation system USB mass storage, so that it can use the memory card for data storage and transmission. The memory card can be dismounted. of the computer use the same protocol of USB mass storage to communicate with the memory card for information transmission. This kind of method can also be applied to the other type of data transmission protocol.

With respect to the information storage card installed in the digital apparatus, the single storage card can have two different connectors, of which one can be the plug of the invention in reduced thickness for the USB connecting manner. As a result, the information storage card can used the USB manner to be directly connected to the external apparatus, such as the computer system.

For the eighth application, one connector is to be connected to one connector on the CF card as shown in seventh application. The connector can be the plug 50 of the invention, which can be connected to the USB plug or the USB receptacle of series A, series Mini-A, series Mini-B. The connector can be the plug 50 with the metal connection terminals 52 as the elastic plate. The plug 50 in implemented with a second holder 54, so as to hold the metal connection terminals 52, which can be a design of elastic plates. In this manner, the plug 50 can be connected to another reversed plug 50 from up side or down side. The second holder 54 in the plug 50 can be implemented with at least a protruding part 58 at the edge, so as to prevent a reversed connection from occurring.

In ninth application, one connection apparatus, used in the computer system as described in seventh application, has the design of at least two connector, so as to connect to at least two different connectors on a single information storage card. One of the two connector can be the connector as described in eighth application and the other one is used to be connected to a memory card, such as IC card, CF card, SD card, multimedia card, XD picture card, memory stick duo card, secure multimedia card, memory stick, MG memory stick, a Microdrive card, a PCMCIA card, or smart media card. The single data storage card can include a master card with an independent card, as described in embodiment 3.

In tenth application, referring to FIG. 1 again, a conventional USB series A plug 10 has the thickness of 0.45 cm, which can be plugged into the USB series A receptacle 20 in FIG. 2. The plug 10 has multiple metal connection terminals 12, used to be connected to have the electrical connection with the multiple metal connection terminal 22 on the first holder 24 of the receptacle 20 when the plug 50 is connected to the receptacle 20. The metal frame 16 of the outer frame is used to contact in connection with the outer frame 26 of the receptacle 20.

Referring to FIG. 18, it is a drawing, schematically illustrating another plug with reduced thickness according to the invention. The invention is implementing another plug 60 on a CF card. The plug 60 has a reduced thickness by less than about 0.38 cm or even down to 0.28 cm, which is less than the thickness of the conventional USB series A plug. It can satisfy the requirement from the CF card by 0.33 cm or approach to the thickness of the memory stick card by 0.28 cm, so as to achieve the thickness used in PCMCIA card. As a result, the plug 60 can be implemented on the CF card or the memory stick card. It only needs to allow to be plugged into the CF slot. The plug 60 can be plugged into the USB series A receptacle 20 in FIG. 2. The plug 60 can be directly affixed onto a CF card. A receptacle on the USB cable for series A can be connected to the plug 60. The plug 60 has a second holder 64, used to hold the metal connection terminals 62. Also and, when the plug 60 is connected to the receptacle 20. At least one of the elastic plates 28 on the outer frame 26 of the receptacle 20 at the up side and each the edge side can elastically contact the outer frame 66, such as a metal frame, of the plug 60. Thickness of the second holder 64 is less than the thickness of the second holder 64 of the conventional USB series A plug 10, so as to reduce the total thickness of the plug 60. The second holder 64 can also be used just for holding the metal connection terminals 62 without need to cover the whole metal connection terminals 62 from the bottom. It can have an outer frame 66, like the metal frame 16 but thinner, to enclose the second holder 64. The bottom of the second holder 64 optionally has the outer frame 66. When the plug 60 is plugged into the receptacle 20, the outer frame 66 is inserted into the space between the first holder 24 of the receptacle 20 and the metal frame 16. The outer frame 66 contacts the metal frame 26 of the receptacle 20. At least one of the elastic plates 28 on the metal frame 26 at the up and each edge sides is elastically contacting with the outer frame 66, so as to provide the affixing effect. As a result, the second holder 64 and the metal connection terminals 62 being held can tightly contact on the first holder 24 on the receptacle 20 and the metal connection terminals 22. The elastic plates 28 on the metal frame 26 at the middle bottom may not contact the plug 60 due the reduction of thickness. One of the purposes of the second holder 64 or the metal frame 66 is to connect in contact the outer frame 26 of the receptacle 20, so as to provide an affixing function.

The metal connection terminals 62 on the second holder 64 can also be a design of elastic plates, wherein each element of the plug 60 is compatible, in specification and appearance, with the USB series A plug 10, which is used to be plugged into the receptacle 20. However, the specification and the appearance can also be modified. For example, the metal connection terminals 62 can be the exposed protruding terminals. It only needs to have a good contact between the metal connection terminals 62 of the plug 60 and the metal connection terminals 22 of the receptacle 20. It is also not the absolutely necessary for the second holder 64 to cover the whole metal connection terminals 62 from the bottom. The second holder 64 can only be used to hold the metal connection terminals 62 from a bottom. The preferred embodiment is to assure for holding and protecting the metal connection terminals 62. The thickness of the plug 60 can be (1) the thickness of the outer frame 66, (2) the thickness between the outer frame 66 and the second holder 64( that thickness is thickness of the first holder 24 of the receptacle 20), and (3) the total thickness of the second holder 64 of the plug 60 and the metal connection terminals 62. The total thickness is less than 0.38 cm or can even down to about 0.28 cm. The plug 60 can be affixed onto the CF card. The plug 60 at each edge side has a space, where a USB cable with series A receptacle can be connected with the plug 60. The plug 60 can also be designed by a rotation arm or a retractable design, so that the plug can be directly plug into the receptacle, the outer frame 66 can be only keep the top side, and remove bottom, or other side.. The log thin connector can prevent from the difficulty of insertion action due to the over large volume of the CF card. The outer frame 66 can optionally keep only the upper part in which the side and the bottom part are removed.

In conclusion, comparing with the conventional USB connector, the plug of the. invention can effectively reduce the thickness of the plug, which can be connected to the USB plug or USB receptacle. Then, the invention allows the peripheral device of computer to be designed with better appearance and having more options, and the design principle for the master card and independent card can be used in other different type of memory cards. In the foregoing different portable memory card. design, the electrical connection with the multiple metal connection terminals 62 or metal connection terminals 52 include the connection of voltage source Vcc and ground voltage GND. The number of GND connection terminals or the Vcc terminals can be reduced. The GND terminal can even be removed, and instead the frame 66 or 56 can be used as the GND connection terminal. This is because the communication distance is short.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A plug, used to connect with a USB receptacle, wherein the receptacle has an outer frame including at least four elastic plates located at inner side of the outer frame, and a first holder, wherein a plurality of metal connection terminals are implemented on the first holder, the plug comprising:
a plurality of metal connection terminals being exposed, used to correspondingly contact the metal connection terminals of the receptacle when the plug is electrically connected to the metal connection terminals of the receptacle; and
a second holder, used to hold the metal connection terminals of the plug, wherein after the plug is connected to the receptacle, at least two of the elastic plates of the receptacle at top are not contacting the plug.

2. The plug of claim 1, wherein between the inner side of the outer frame and a first surface of the first holder, a first space is formed, and the second holder has a protruding part, and the protruding will insert into the first space when the plug and the receptacle are connected.

3. The plug of claim 1, wherein after the plug and the receptacle are connected, at least one of the elastic plates contacts the plug and at least one of the elastic plates is located at bottom inner side of the outer frame.

4. The plug of claim 1, wherein the second holder comprises at least one elastic plate, and the least one elastic plate contacts the receptacle after the plug is inserted to the receptacle.

5. The plug of claim 4, wherein a first space is formed between the inner side of the outer frame and a first surface of the first holder, as well as an edge of the metal frame is inserted into the first space when the plug and the receptacle are connected.

6. The plug of claim 4, wherein the metal frame has an opening, which is located at a position with respect to a power terminal of the receptacle when the plug is connected in reverse to the receptacle.

7. The plug of claim 1, wherein the receptacle includes a USB series A receptacle, and the thickness of the plug is less than about 0.38 cm.

8. The plug of claim 1, wherein the plug is installed an apparatus.

9. The plug of claim 8, wherein the apparatus has an indent space, and the plug is implemented within the indent spacer and can be shifted out or retract back, when the plug is to be connected to the receptacle, the plug is shifted out and when the plug is not connected to the receptacle, the plug remains in the indent space.

10. The plug of claim 8, wherein the apparatus is silicon disk or memory card.

11. The plug of claim 1, further comprising a protection cap, which can be implemented on the second holder in retractable function, wherein the first holder is located between the protection cap and the second holder when the plug and the receptacle are connected.

12. A plug, used to connect with a USB Series “Mini” receptacle, wherein the receptacle has an outer frame including at least one elastic plates located at inner side of the outer frame, and a first holder, wherein a plurality of metal connection terminals are implemented on the first holder, the plug comprising:
a plurality of metal connection terminals being exposed, used to correspondingly contact the metal connection terminals of the receptacle when the plug is electrically connected to the metal connection terminals of the receptacle; and
a second holder, used to hold the metal connection terminals of the plug, wherein the second holder optionally includes a frame.

13. The plug of claim 12, wherein the thickness of the plug is less than 0.15 cm.

14. The plug of claim 12, wherein after the plug is connected to the receptacle, at least one of the elastic plates elastically contacts the plug.

15. The plug of claim 12, wherein between the inner side of the outer frame and a first surface of the first holder, a first space is formed, and the second holder has a protruding part, and the protruding inserts into the first space when the plug and the receptacle are connected.

16. The plug of claim 12, wherein the receptacle comprises USB series Mini-A, series Mini-B, or series Mini-AB.

17. The plug of claim 12, wherein the plug is installed on a digital apparatus.

18. The plug of claim 17, wherein the apparatus has an indent space, and the plug is implemented within the indent spacer and can be shifted out or retract back, when the plug is to be connected to the receptacle, the plug is shifted out and when the plug is not connected to the receptacle, the plug remains in the indent space.

19. The plug of claim 17, wherein the apparatus is silicon disk or memory card.

20. A plug, used to connect with a USB connector, wherein the USB connector has an outer frame, and a first holder, wherein a plurality of metal connection terminals are implemented on the first holder, the plug comprising:
a plurality of metal connection terminals being exposed, used to correspondingly contact the metal connection terminals of the receptacle when the plug is electrically connected to the metal connection terminals of the receptacle; and
a non-metal second holder, used to hold the exposed metal connection terminals of the plug, wherein the plug optionally includes a metal frame, whereby the thickness of the plug is less than about 0.38 cm

21. The plug of claim 20, wherein when the second holder has at least one elastic plate, and the at least one elastic plate elastically contacts the USB connector after the second holder is inserted to the USB connector.

22. The plug of claim 20, wherein the USB connector has an outer frame with at least one elastic plate, the at least one elastic plate elastically contact the plug after the plug is inserted into the USB connector.

23. The plug of claim 20, wherein the second holder contacts the outer frame of the connector after the plug is inserted into the USB connector.

24. The plug of claim 20, wherein the USB connector comprises one of plugs and receptacles in one of USB series Mini-A, series Mini-B, and series Mini-AB.

25. A memory card comprising:
at least one memory part, used to store information;
at least one controller, used to control data communication, wherein the controller optionally is integrated with the memory part;
a plug, capable of being put back, used to connect to a connector of a USB series; and
optionally a first I/O port, used to be externally connected to a second I/O port, wherein the memory card can select the first I/O port or the plug to connect to an electronic device for information communication, wherein the thickness of the memory card is less than 0.38 cm.

26. The memory card of claim 25, comprising one selected from the group consisting of an IC card, a CF card, a SD card, a multimedia card, an XD picture card, a memory stick card, a memory stick duo card, a MG memory stick card, a smart media card, a Microdrive card, a PCMCIA card, and a USB silicon disk,.

27. The memory card of claim 25, wherein the plug, the memory part, and the at least one controller can be separated from the memory card to form another independent memory card.

28. A memory card comprising:
a memory part, used to store information;
a controller, used to control information communication, optionally can be integrated with the memory part;
a plug, capable of being put back, used to be connected to a connector; and
optionally a first I/O port, used to be externally connected to a second I/O port;
wherein the memory card can select the first I/O port to connect to the second I/O port of an electronic device, or select the plug to connect to a connector of an electronic device, so as to have information communication,
wherein the memory card comprises one selected from the group consisting of an IC card, a CF card, a SD card, a multimedia card, a XD picture card, a MG memory stick card, a memory stick duo card, a memory stick card, a smart media card, a Microdrive card, a PCMCIA card, and a USB silicon disk.

29. An information storage device, connected with a digital device for data access, the information storage device comprising:
a memory part, used to store information;
at least one controller, used to control information transmission, and optionally being integrated with the memory part;
at least two different I/O connectors, wherein one of the at least two I/O connectors includes a plug, which can be connected to a USB series A connector of the digital device, the plug comprises:
a plurality of exposed metal connection terminals being exposed, used to electrically connect to corresponding metal connection terminals of the USB series connector after the plug is connected to the USB connector, a thickness of the plug is less than 0.38 cm; and
a non-metal holder, used to holed the metal connection terminals of the plug,
wherein the holder can optionally include a metal frame rack,
wherein the memory part comprises one selected from the group consisting of an IC card, a CF card, a SD card, a multimedia card, a XD picture card, a MG memory stick card, a memory stick duo card, a memory stick card, a Microdrive card, a PCMCIA card, and a USB silicon disk.

30. A connecting device, comprising:
at least two connectors, for connecting at least two different connectors installed on a single information storage device, which has been plugged therein; or capable of connecting to one connector installed on the single information storage device.

31. The memory card of claim 30, wherein the single information storage device comprises one selected from the group consisting of an IC card, a CF card, a SD card, a XD picture card, a memory stick duo card, a memory stick card, a multimedia card, a MG memory stick card, a smart media card, a Microdrive card, a PCMCIA card, and a USB silicon disk.

32. The memory card of claim 30, wherein the single information storage device includes a master card associating with an independent card

33. A connection architecture of an information storage device, implemented inside of a digital apparatus; comprising at least dual connector; and a slot, allowing a single information storage device to be plugged in, wherein the single information storage device includes at least two different connectors or at least one single connector, wherein the at least dual connector can be connected to at least two different connector or the at least one connector on the single information storage device, which is plugged into the single slot.

34. The connection architecture of claim 33, wherein the single information storage device comprises one selected from the group consisting of an IC card, a CF card, a SD card, a multimedia card, a XD picture card,, a memory stick duo card, a MG memory stick card, a smart media card , a Microdrive card, a PCMCIA card, and a USB silicon disk.

35. The connection architecture of claim 33, wherein the single information storage device includes a master card associating with an independent card.

36. A plug, used to connect with a USB series A receptacle, wherein the receptacle has an outer frame including at least four elastic plates located at inner side of the outer frame, and a first holder, wherein a plurality of metal connection terminals are implemented on the first holder, the plug comprising:
a plurality of metal connection terminals, used to correspondingly electrically connect to the metal connection terminals of the receptacle when the plug is electrically connected to the metal connection terminals of the receptacle; and
a second holder, used to hold the metal connection terminals of the plug; and
an outer frame, used to insert into the outer frame of the receptacle;
wherein a thickness of the plug is less than about 0.38 cm.

37. The Plug of claim 36, wherein the second holder has a reduced thickness, so that the thickness of the plug is less than about 0.38 cm.

38. The Plug of claim 36, wherein after the plug is connected to the receptacle, at least one of the elastic plates of the receptacle at bottom is not contacting with the plug.

39. The plug of claim 35, wherein the plug is implemented on an apparatus, and the apparatus has an indent space, the plug can be inner packed in the indent space, when the plug is to be connected to the receptacle, the plug can be shifted out from the indent space, and when the plug is not connected to the receptacle, the plug can be shifted back into the indent space.

40. A memory card A comprising:
at least one memory part, used to store information;
at least one controller, used to control information communication, optionally being integrated with the memory part;
at least one plug, which can be used to connected to a connector of a USB series for information communication with an electronic device ; and
optionally comprising a first I/O port to connect to the second I/O of an electronic apparatus A;
wherein a memory card B can be released from or retracted back to the memory card A, and the memory card A can provide the function of storing and accessing information on the memory card B, the memory card B can be plugged into a card slot,
wherein the memory card B includes one selected form the group consisting of an IC card, a CF card, a SD card, a multimedia card, a XD picture card, a memory stick card, a memory stick duo card, a MG memory stick card, a smart media card, a Microdrive card, a PCMCIA card, and a USB silicon disk,
wherein the memory card A can select the first I/O port or the plug to connect to the second I/O port of the electronic apparatus A, so as to have information communication,
wherein the memory card B optionally includes a controller and an I/O port for connecting with an external electronic apparatus B to control information transmission.

41. The memory card A of claim 40, wherein the memory card comprises one selected form the group consisting of an IC card, a CF card, a SD card, a multimedia card, a XD picture card, a memory stick card, a memory stick duo card, a MG memory stick card, a smart media card, a Microdrive card, a PCMCIA card, and a USB silicon disk.

42. A memory card architecture, comprising:
a master card, having an I/O port, capable of connecting with a first external electronic device;
a first controlling unit, implemented on the mater card, used to convert the I/O port into a USB interface; and
a memory card, having a second control unit and a USB interface I/O port member, capable of connection with a second external electronic device,
wherein the memory card can be mounted on the master card as a choice from a user, and by a mechanical operation or a direct connection, the USB interface I/O port member can be coupled with the USB interface,
wherein only one at a time can be selected for information communication from the group consisting of case 1 that the USB interface I/O port member of the memory card is coupled with the USB interface and case 2 that the USB interface I/O port member of the memory card is coupled with the second external electronic device.

43. The memory card architecture of claim 42, wherein when the memory card is mounted on the master card, the first control unit and the second control unit can be optionally coupled together.
